(19) United States
(12) Patent Application Publication
(10) Pub. No.: US 2016/0162382 A1
(43) Pub. Date: Jun. 9, 2016

(54) SYSTEM THAT COMPARES DATA CENTER EQUIPMENT ABNORMALITIES TO SLAS AND AUTOMATICALLY COMMUNICATES CRITICAL INFORMATION TO INTERESTED PARTIES FOR RESPONSE

(71) Applicant: EdgeConneX, Inc., Herndon, VA (US)

(72) Inventor: Lance Bennett Devin, Vienna, VA (US)

(21) Appl. No.: 14/802,356

(22) Filed: Jul. 17, 2015

Related U.S. Application Data
(60) Provisional application No. 62/123,903, filed on Dec. 3, 2014.

(51) Int. Cl. G06F 11/30; G06F 11/34

(52) U.S. Cl. CPC G06F 11/3034; G06F 11/3058; G06F 11/3433

(57) ABSTRACT

A system that compares data center equipment abnormalities to SLAS (Service Level Agreements) that automatically communicates critical information to interested parties for response.

This application is based on provisional application Ser. No. 62/123,903 filed Dec. 3, 2014

### FEDERALLY SPONSORED RESEARCH STATEMENT

Not Applicable

### REFERENCE TO SEQUENCE LISTING, A TABLE OR A COMPUTER PROGRAM LISTING

Not applicable

### BACKGROUND OF THE INVENTION

1. Field of the Invention

In today's communication and data management environment the always-on, always-ready business climate demands continuous, uninterrupted information availability. Because network availability and data access are essential parts of successful business operations, data centers have become an integral part of a business's daily operations. Data center dependence has resulted in complicated needs to ensure immediate service and, to the extent possible, continued efficient operation and, most importantly, the prevention of customer-equipment-affecting power outages. Proactive network, systems management and communications are required to maintain such efficient and continuous operation. It is, therefore, critical to have rapid and secure access to the data center infrastructure and status, wherever they are located and at any time, in order to provide a reliable infrastructure for data center operations.

The costs for energy usage and personnel to assure the reliable continuous operation of a data center can be prohibitive if not adequately managed and controlled. Recent developments in data center operation have seen the evolution of unattended data centers sometimes referred to as “lights out data centers”. In such centers, access is limited. Obviously, the more you limit access, the less cooling escapes as doors are opened and less energy is used to maintain proper temperatures. Other benefits include improved security, reduction in damaged cabling and equipment, less theft and misappropriations of equipment, lowered insurance costs, quicker response times, and better allocation of labor intensive situations. While there are many benefits to the lights out data center, it also poses operational challenges with respect to managing customer's expectation of power and cooling.

The present invention relates to the automatic operation and management of data centers in which there are customers with server equipment and who are provided services in the data center pursuant to a service level agreement. The inventive operating system is particularly suited for utilization in unattended data centers including the monitoring and control of power usage, humidity, temperature, preventive and corrective maintenance requirements, adherence to multiple customer service level agreements and physical access to the data center infrastructure. In particular the inventive system has the capability to automatically determine if any abnormal condition occurring in the data center is one that violates the service level agreement of a specific customer and provides the ability to communicate with that customer as well as alerting the appropriate personnel to correct the abnormality.

2. Discussion Of The Prior Art

In recent years there has been technological developments related to the operation and management of data centers in general and in unattended data centers in particular. In the prior art known to the inventor of the present invention, none provide the automatic management and control of data center operations as disclosed herein.

A prime example of the prior art is U.S. Pat. No. 6,567,769 B2 that is directed to an unattended data center environment protection, control and management system that is able to provide means for monitoring temperature and humidity, managing power supply, and controlling access condition for a protected zone, and further, able to achieve the aim of remote control and management effect in any situation and from any distance by means of phone communication, interconnection to local network, or the internet web. There is no disclosure in that patent that provides for the management of a data center that is automatically controlled, provides for the automated dispatch of corrective maintenance personnel, and has the capability to be responsive to customers' service level agreements.

Another relevant example of the prior art is U.S. Pat. No. 8,103,480 B2 that is directed to a system for evaluating service level agreement violations that includes the storing of a model of the service level agreement and identifying an occurrence of a violation of that agreement. There is no mention or disclosure in that patent of the capability to automatically provide information about the violation to the customer or operator, and further, provide directions to have the violation corrected. Additionally, there is no mention of the requirement for multiple data center equipment statuses to be analyzed in combination and as integrated systems visa vie Service Level Agreement and the ability to take automated corrective action.

### BRIEF SUMMARY OF THE INVENTION

The inventive data center operating system overcomes the disadvantages of the prior art by providing a data center facility manager capable of automating management, control and communications. In the preferred embodiment the operating system is capable of automatically managing a plurality of data centers wherein each data center has more than one customer with each customer having different service requirements, and with no operational staff being present at the site of any of the centers. The invention merges many known independent and novel operational management controls and procedure in a unique manner.

Each service level agreement (SLA) defines customer specific operational requirements to be met by the data center. The operating system uses PLC ladder logic to provide an automated SLA management and root cause analysis of data points for rapid response and dispatch of technicians, and notification to customers. The facility manager is fed information related to every piece of equipment located in the data center. The programmable logic controller (PLC) ladder logic reads the data (at a typical rate of 25,000 data points per the five minute intervals) and determines the severity of any abnormalities. As will be explained in great detail below, a detected problem is classified in one of three categories. The first category includes problems that are tagged for watching with no immediate needed response. The second category includes problems that must be addressed by the data center personnel. The third category includes those problems that require notification to the customer pursuant to the SLA for that customer. The inventive operating system supports a set of requirements (rules) for each customer and independently evaluates the detected problems in conjunction with the SLA. The systems provides for automatically tracking of a corrective action for any detected abnormality, hereinafter referred to in this disclosure as the Ticket Manager.

### BRIEF DESCRIPTION OF THE SEVERAL VIEWS OF THE DRAWING (FIG. 1)

FIG. 1 is an interaction model of systems, subsystems, ancillary systems, and information of the preferred embodiment of the invention.

### DETAILED DESCRIPTION OF THE INVENTION

As is explained below, the invention is an automated system that senses the physical condition of the data center equipment (mechanical, electrical, and computer) that registers abnormalities and compares them to customer service level agreements (SLA), in order to react, correct and communicate as appropriate to interested parties (operations, customers, and maintenance vendors).

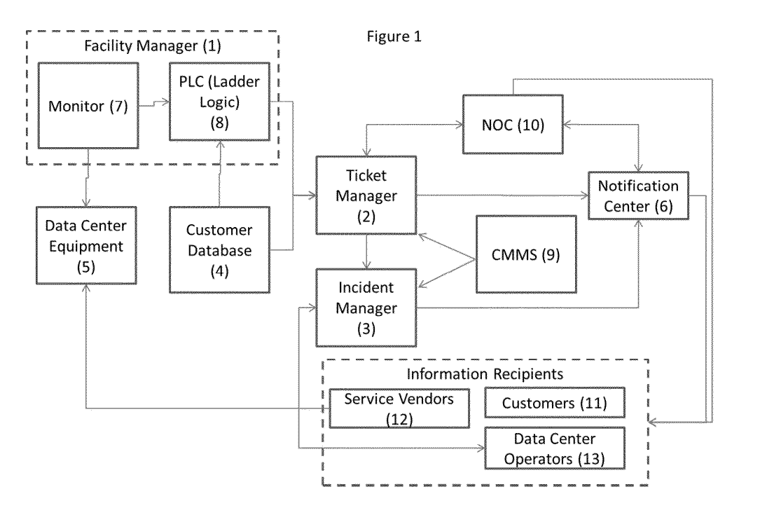

FIG. 1 shows the interaction model of a data center system, subsystems, ancillary systems, and information used to provide an automatically responsive service level management agreement (SLA) management system. That system consists of facility manager 1, ticket manager 2, incident manager 3, customer data base manager 4, the representation of all monitored equipment that is located in a data center 5, notification center 6, monitor 7, PLC (logic ladder) 8, computerized maintenance management system (CMMS) 9, and network operations center (NOC) 10, Information recipients are designated as customers 11, service vendors 12 and data center operators 13. Facility manager 1 consists of monitor 7 and programmed logic controller (PLC) 8. That software toolkit encompasses tools for customizing monitor 7 and PLC 8. Facility manager 1 incorporates data from ticket manager 2, CMMS 9, customer database 4 and other systems and is utilized by data center operators 13 and service vendors 12.

Facility Manager 1 is a bespoke, ActiveX-based, web-application that has been written using commercially available SCADA-based toolkits (“Iconics”), specifically to the requirements of Data Center Information Management.

Ticket Manager 2 is a stand- alone, bespoke, web portal application written as proprietary software development specific to mission critical environments (cannot become dysfunctional) such as nuclear plants, data centers and off-shore oil rigs, to manage the flow and tracking of issues.

Incident manager 3 is a stand- alone, bespoke, web portal application written as proprietary software development specific to mission critical environments, to manage SLA violations in mission critical environments, specifically data centers.

Customer database 4 is a stand-alone product that has a proprietary user interface utilized by data center operators 13. It provides for the storage of contact information, computer-room cabinet information, and allowed communications by individuals. It also maintains an escalation order of communications.

Data Center Equipment 5 represents and encompasses a database that is part of and 155 maintained by the commercially available CMMS system 9. It stores relevant information about the data center assets/equipment such as put in service date, model names, serial numbers, company asset ids, and more importantly, a hierarchy related to the assets.

Notification Center 6 is a bespoke application integrated into the inventive system. It uses industry standard protocols for outbound communications including but not limited to SMS, SMTP, etc. Notification center 6 uses templates for communication that draws information from various other systems in the invention as outlined below.

Monitor 7 is a component toolkit of the commercially available Facility Manager 1. It uses standard communication protocols (SNMP over Ethernet, Modbus, etc.) to receive equipment status data (Points). That information is stored in a database and analyzed visa vie SLA information.

PLC (Ladder Logic) 8 is bespoke computer programming that is a component of Facility Manager 1. It analyzes points provided by Monitor 7 in order to determine root cause and impact of equipment readings.

CMMS (Computerized Maintenance Management System) 9 is a proprietary version of commercially available software. The CMMS system is responsible for storing information with regards to assets. It manages work to be done within the Data Center as it pertains to those assets. Typical work defined in the system includes maintenance on asset equipment and customer requests for power. It is important that users understand these processes so they can better understand the data being presented to them in the CMMS.

NOC (Network Operations Center) 10 represents personnel responsible for managing Ticketing Manager 2, and communications to customers on a 24 hour, every-day basis. That personnel coordinates activities between Customers 11 and Service Vendors 12, and data center operators 13.

Customers 11 are organizations that have computer equipment in the data center and lease space, power, and cooling from the operator. Service Vendors 12 are contractors to the data center operator who are responsible for the maintenance of equipment that provide power and cooling throughout the data center. Data center operators 13 are personnel hired by the data center owner, who are responsible for the data centers proper operation with respect to power, cooling, customers and virtually all aspects of the data center.

In operation, Facilities manager 1 monitors the information coming from equipment in the data center using protocols such as SNMP, Dry Contact, ModBus, or other standards. It is the sole view into the state of the data center. It reads, in a SCADA-like fashion, approximately 25000 points of information per data center coming from monitored equipment. Each piece of equipment is monitored on different intervals between 1 and 5 minutes, as defined in the system. All monitored information is maintained in a centralized database called a historian. There is a centralized historian for all data centers and there is a historian at each individual data center. In the case of failures at the centralized database or local database, a third geographic location holds a disaster recover snapshot of the centralized database and can be started to resume normal operations of all systems .

Monitor 7 polls for and receives information from the data center's monitored equipment 5, and that data is analyzed by PLC 8. It is to be understood that the monitored equipment includes but is not limited to, the mechanicals (e.g. air handling and conditioning, etc.), electricals (e.g. switch boards, breakers, Uninterruptable Power Supply, Transfer Switches, Power Distribution Units, Remote Power Panels, etc.), environmental condition sensors (e.g. temperature and humidity) and computers. PLC 8, utilizing a set of pre-determined rules programmed into programmable ladder logic software and defined by data center operators 13, determines if there is an abnormality or problem in any of the monitored equipment. Abnormalities may be based on a single item of information, sometimes referred to as a “point” in this specification, from a particular piece of equipment or based on a series of points from multiple pieces of equipment that in pre-described combinations indicate an abnormality. The ladder logic programming PLC 8 has the capability of determining the severity of any abnormality by an operator (13)-definable set of rules. In addition, PLC 8 has the capability of determining with a high percentage of certainty the specific piece (or pieces) of equipment that is the cause of the abnormality. This capability is important since in many instances the interrelationship of the pieces of equipment results in the detection of a plurality of abnormalities caused by a single problem. To better appreciate this capability, it is stipulated that data centers are comprised of interconnected systems through electrical mechanical and computer networks usually referred to as an inter-dependent network of interactions. As such there are failures that can cascade from one piece of equipment to another. For example, if a power distribution unit (PDU) fails in certain ways, alarms at equipment connected to that PDU (e.g. Remote Power Panels, “RPP”) will also be triggered. Data center personnel subjected to all of these alarms will not know immediately which of the alarms to attend to first and if one piece of equipment caused another piece of equipment to fail. PLC 8 deterministic algorithms save valuable time and identify root causes of the failure. Additionally, with un-manned data centers, dispatching the correct maintenance teams based on root cause analysis, will mean that problems are addressed the first time, more quickly and accurately. PLC 8 applies logic to read data both on a per-point basis and across multiple points and devices to intelligently identify the probable root cause on an immediate basis. Because PLC 8 creates a Ticket 2 and/or Incident 8, it is important that only the root cause is documented in those systems, otherwise the output data from Ticket Manager 2, Incident Manager 3, and PLC 8 would be too voluminous to take coherent actions by Service Vendors 12 and Data Center Operators 13.

Further, the inventive system classifies a detected abnormality into one of three pre-determined categories, and automatically treats the abnormality in accordance with specified rules as explained in greater detail below.

The first category includes abnormalities in equipment in which no immediate action is required. The piece of equipment that exhibits this category of abnormality is tagged for closer analysis through trended data. The second category includes abnormalities and/or problems impacting data center operation that must be immediately addressed by data center operators 13 but does not impact a customer service level agreement (SLA) so that no customer notification or involvement is necessary. It is to be understood that each customer service level agreement (SLA) defines specific operational tolerances or operational boundary conditions of the data center that impacts that customer in the data center. It is to be noted that PLC 8 determines which customers are impacted by each individual piece of equipment in order to automatically respond to the customer for a given equipment failure. As the equipment are ordered into a well-defined hierarchy; customer impact, maintenance and monitoring is comprehensively represented to the PLC 8, Ticketing Manager 2 and Incident Manager 3. The third category of abnormalities include those abnormalities or problems that must be immediately addressed by data center operators 13 and that require notification to the customer pursuant to the SLA for that particular customer. In the preferred embodiment of the invention the first category facility event is referred to as “informational” and is given a yellow designation; the second category facility event is referred to as “alert” and is given an orange designation and the third category facility event is referred to as an “incident” and an “Alarm”, and is given a red designation.

Through the utilization of PLC 8 all facility events are evaluated to determine whether a particular abnormality is to be classified as an “alert”, “critical” or “incident”. An “informational” designation indicates that the abnormality is not serious enough to warrant immediate action. That abnormality is targeted to be closely monitored. As is explained in greater detail below if it is determined that the abnormality is “critical”, details about that abnormality, the designated service vendors, and maintenance history will be automatically provided to ticket manager 2 to help address the situation. Ticket manager 2 is accessed and used by NOC 10, service vendors 12, customers 11 and data center operators 13. While the concepts in ticket manager 2 may be found in commercially available software packages the implementation thereof has customized integrations and automation specific to data center operations. If the abnormality falls under the type in which the customer must be notified pursuant to the SLA, the information about such abnormality will be provided to incident manager 3 in accordance with the operation of the system.

Once an abnormality is determined and classified as an alert or an incident according to the parameters explained above, the information about the abnormality is delivered to ticket manager 2 and/or incident manager 3.

Ticket Manager 2 aggregates pieces of information that are used to create actionable, coordinated events in the data center between interested parties (e.g. customers, maintenance personnel, operational personnel).

The ticketing system presents itself in a web portal accessible to users mentioned above who are authorized to use the system. Depending on user class, the portal and ticketing system will present differently.

The information provided to the Ticketing Manager 2 includes: facility event and root cause from facility manager 1, equipment data (models, serial number, service vendor 12, etc.) from the computerized maintenance management system (“CMMS”) 9 data base, lists of customers 11 and contact information from the customer database 4 that have been designated to receive alert or incident notifications.

CMMS 9 is responsible for categorizing work to be done at the data center to data center assets. Work categories include but are not limited to preventive or corrective maintenance, engineering tasks, safety tasks, etc. The purpose of the CMMS 9 is to manage work to be done within the data centers and as such is used by service vendors 12 and data center operators. Aspects of CMMS 9 are incorporated into a set of operational screens within facility manager 1. Typical work defined in the system includes maintenance on asset equipment (corrective and preventive) and customer requests for power enhancements (engineering tasks). All data center assets are recorded in CMMS 9 in a hierarchical fashion, as are the vendor information for those assets. All data centers are recorded in the CMMS 9.

The incident related information is sent to notification center 6 from incident manager 3 and/or ticket manager 2 so that the appropriate persons can be notified thereof. If the abnormality is deemed to be of the red or incident status facility manager 1 provides the customer information from customer data base 4 to incident manager 3. For Incidents, additional procedures and operations are defined: data center operators 13 are alerted to make a verification of the incident in incident manager 3, and if approved as a true incident, notification center 6 is automatically provided contact and other relevant information specific to that customer for the aforementioned pre-determined abnormalities. Approvers, data center operators 13, of incidents are specified in the system on a per data center basis as maintained in the Customer Database 4 to possibly limit the responsibility of operator scope. Incidents have the following statuses as they are tracked by Information Recipients (11, 12 and 13): Pending, Notified, Cancelled, and Completed.

The customer manager and database 4 provides the incident manager 3 and/or ticket manager 2 with the names and contact information of those customers 11 that need to be made aware of an abnormality and a listing of the customer personnel needed to be notified and included in the incident or ticket communications. Notification center 6 receives information from ticket manager 2 and incident manger 3 to control and manage communications (e.g email, pages, texts, phone dialing).

Incident manager 3, ticket manager 2 and facility manager 1 asserts no control over the systems as that is left to data center operators 13. They are meant to automate the flow of information from equipment to operators and subsequent users of that information. As there is an overwhelming amount of data, systematic intelligence (PLC 8) has been crafted into the system to alert on critical information while maintaining all information

Network Operations Center (“NOC”) 10 is responsible for managing the notifications from the ticket manager as a twenty four hours, seven days a week facility. As a manager of tickets, NOC 10 is responsible for synchronizing and overseeing communications to facilities services (repair and service vendors 12, customers 11, and data center operators 13. NOC 10 makes sure that all appropriate work is accounted for in ticketing manager 2.

A ticket's status is limited to being open, being in progress, being closed or being cancelled. An open ticket is one that has not yet been acted upon. A ticket in progress is one being actively worked on. A closed ticket is closed when the equipment involved has been successfully acted upon. A cancelled ticket is one that has been deemed invalid by authorized personnel.

Once a ticket is issued on a specific piece of equipment via ticket manager 2 the inventive system will not approve the issuance of another automated facility manager 1 ticket on the same piece of equipment for the same situation. The system presumes that the corrective maintenance will be carried out and subsequent tickets are redundant. A facility manager 1 automated ticket may only be closed when the equipment has been serviced and the monitored data point is reset to normal readings at the location of the asset, in order to ensure that service has been appropriately completed.

There has been provided herein an approach to provide a system that compares data center equipment abnormalities to SLAS and automatically communicates critical information to interested parties for response. While the invention has been particularly shown and described in conjunction with a preferred embodiment thereof, it will be appreciated that variations and modifications will occur to those skilled in the art. Therefore, it is to be understood that the claims are intended to cover all such modifications and changes as fall within the true spirit of the invention.

1. In a facility housing equipment owned by an operator, said operator being subject to an agreement with one or more customers of said facility with said agreement defining services related to said equipment, an automatic system for detecting abnormalities in said equipment including;
first means for sensing the physical condition of said equipment,
second means for determining the nature of any detected abnormalities in said equipment, and third means for communicating said detected abnormalities to pre-determined recipients.

2. The system of claim 1 wherein said agreement defines specific levels of service to be
rendered by said equipment to customers of said facility.

3. The system of claim 1 where there are separate and distinct levels of service for each customer.

4. The system of claim 2 where there are separate and distinct levels of service for each customer.

5. The system of claim 1 wherein said sensed abnormalities is automatically compared to terms in said agreement and stored in system of claim 2.

6. The system of claim 18 wherein said determination means: identifies the specific equipment experiencing a detected abnormality.

7. The system of claim 2 wherein said determination means identifies the specific equipment experiencing a detected abnormality.

8. The system of claim 1 wherein said determination means classifies a detected abnormality into one of a plurality of pre-determined classes one of which includes abnormalities in which immediate remedial action is not required.

9. The system of claim 7 wherein said determination means classifies a detected abnormality into one of a plurality of pre-determined classes one of which includes abnormalities in which immediate remedial action is not required.

10. The system of claim 9 wherein a second class of abnormalities does not impact said service agreement.

11. The system of claim 10 wherein a third class of abnormalities requires notification to said customer.

12. The system of claim 11 wherein there is provided means for creating actionable coordinated events to be reacted upon by pre-determined parties.

13. The system of claim 12 wherein said events include the determination of the root cause of said detected abnormalities, data related to the identity of said equipment experiencing said detected abnormalities and contact information of parties impacted by said abnormalities.

14. The system of claim 13 wherein only said root cause is provided as the relevant information pertinent to actionable and coordinated events that are to be acted upon by said appropriate parties.

15. A method to communicate abnormalities in equipment housed in an unmanned facility for appropriate response by effected parties including the steps of:
automatically sensing the physical condition of said equipment,
automatically determining the nature of any abnormalities in said equipment, and
automatically communicating said abnormalities to dynamically determined recipients for pre-determined action.

16. The method of claim 15 wherein the determination of the nature of the abnormalities is based on predetermined criteria.

17. The method of claim 16 wherein a determined abnormality is classified in accordance with predetermined criteria.

18. The method of claim 17 wherein said determined abnormality is derived from a single source system of information.

19. The method of claim 17 wherein said determined abnormality is based on heuristics across multiple sources system of information.

20. The method of claim 16 wherein one of said predetermined criteria impacts an existing agreement.

21. The method of claim 15 wherein said step of communicating abnormalities, is augmented with equipment and facility information.

22. The method of claim 21 wherein said augmented with equipment and facility information is equipment maintenance history, specific contact information for repair, and any dependent equipment abnormalities.
